(19) United States
(12) Patent Application Publication
(10) Pub. No.: US 2003/0127512 A1
(43) Pub. Date: Jul. 10, 2003

(54) Secure identification system

(76) Inventors: Jason Graeme Boyd, Perth (AU); Cameron Laurence Brook, Perth (AU); Guido Anthony Berini, Perth (AU)

Correspondence Address: Jason Boyd, P.O. Box 777, Mount Lawley, 6929, AU

(21) Appl. No.: 10/327,919

(22) Filed: Dec. 26, 2002

Related U.S. Application Data
(60) Provisional application No. 60/344,804, filed on Jan. 7, 2002.

(30) Foreign Application Priority Data
Nov. 11, 2002 (AU) 2002301736

(51) Int. Cl. G06K 5/00

(52) U.S. Cl. 235/380

(57) ABSTRACT

A method and system to facilitate secure personal identification of an individual where a user key device is employed to access data stored on a remote system. All relevant data is stored only on that remote system and that data is accessed only by proprietary equipment at a point of operation. The data is temporarily uploaded to and displayed if required on an operator's equipment for verification. The system disclosed can be used to manage and/or enable secure remote funds transfer. A user key device is employed to permit local point of sale equipment and/or the operator of that equipment to verify the ID of a user by accessing personal identification data stored only on a remote facility. No form of personal ID is visible on or stored on the user's key device at any time.

### BACKGROUND

Current security systems or transaction cards or devices rely on information being stored on the card or device itself and may require manual entry of PIN numbers for operation. These systems are prone to simple and effective fraud by unauthorised users.

Present systems often use magnetic stripe based cards, RFID products or EMV style contact reader cards to store user account numbers and other user data. The data from these types of devices is readily accessed, copied and altered using commonly available card readers and fake cards are now often fabricated to permit fraudulent transactions.

Identification card systems also use data stored directly on the cards and are thus prone to the same kind of improper use and manipulations.

### EXISTING AND PROPOSED SYSTEMS ARE LACKING IN PRIVACY AND SECURITY

Recently proposed card systems include security measures such as a visible image of the user on the surface of the card and/or biometric identification such as a user's thumbprint image on the surface of the card. These proposals limit the systems to a card based format and greatly compromise the user's privacy.

There are also systems under development which store user ID data on the card. The SIS system does not store any user ID data on the card itself. The SIS system can be implemented in physical embodiments other than a card format such as a pendant.

### BRIEF SUMMARY

The invention consists of a system employing;

(1) an electronically readable key device (the CKD) which may be self powered or remotely powered and may be of the EMV style (contact read/write) card format or of the RFID type (radio frequency field powered and read/write, either tag transponder or card transponder).

(2) a reader device (the Trans-Reader-Device or TRD) which reads the code stored in non-volatile memory on the key device.

(3) a remote computer system (the RCS) which reads the code from the key device, uploads data to an operator terminal or other relevant on site control equipment, may also upload data to the key device if required, and

(4) proprietary software which enables the data communication and system control.

### BRIEF DESCRIPTION OF DIAGRAMS

Diagram 1 refers to an embodiment of the invention whereby a user engages in a transaction to confirm their identity for the purpose of access control or other required process at an operator attended station.

Diagram 2 refers to an embodiment of the invention whereby a user engages in a transaction to purchase goods at an operator attended point of sale.

Diagram 3 refers to an embodiment of the invention whereby the user undertakes a transaction to purchase goods at an unattended point of sale.

In the above mentioned diagrams the items indicated are defined as below.

Item 1—CKD (contactless user key or EMV compliant card)

Item 2—TRD (a radio frequency functional transmitter and receiver device to interface with contactless key devices, or an EMV compliant card reader to interface with EMV compliant cards)

Item 3—RCS (remote computer system)

Item 4—SC (security console)

Item 5—POS (the vendor's point of sale terminal, cash register or stock tally equipment)

### DETAILED DESCRIPTION OF THE INVENTION

Detailed Description of Components

TRD Unit—(RFID Format)

In the RFID format the TRD is both a radio frequency transmitter and receiver. The TRD supplies energising power to the CKD and manages appropriate data exchange to capture and decode the key code from the CKD.

TRD Unit—(Contact Card Format)

In the contact card format the TRD is typically an EMV compliant card reader.

CKD Device—(Radio Frequency Powered Format)

The CKD contains a micro electronic circuit. The CKD may be physically sandwiched into a PVC card the same dimensions and material composition as a standard credit card or encapsulated into other forms such as a pendant. The circuit consists of several integrated sub circuits including a resonant RF antenna, a charge pump and power storage circuit, a ROM which contains the instruction set for card operation, and two or more data memory registers. The CKD transponder is powered by a burst of RF energy from the TRD which causes the resonant antenna to capture the broadcast RF energy and deliver it to the charge pump and power storage circuit. Upon receiving power the transponder performs according to the instructions stored in the ROM and immediately broadcasts information previously programmed into the first memory register.

CKD Device—(Radio Frequency Powered Format)—Continued.

This is known as the Secure Identification System (SIS) level 1 ID.

The ID code is received by the TRD which then outputs a signal to indicate the presence of a valid transponder. The received ID code itself is sent from the TRD directly to the RCS. The RCS then commands the TRD to obtain further data which is stored in other memory registers on the CKD.

CKD Device—(Contact Card Format)

In this case the CKD is an EMV style card compliant with

EMV2000 version 4.0.

The SIS level 1 ID is stored on a memory register selected by the issuing entity.

RCS Device

The RCS is a computer storage and processing system which is remotely located from the point of user interface. The RCS operates with proprietary software and stores all identification data for system users. The RCS operates with an exclusive data link to the on site interface equipment. The on site equipment includes the TRD unit and any necessary sub systems to perform required functions for that particular location. For example, access control equipment or vendor point of sale equipment.

Detailed Description of System Operation

In operation the data from the TRD is sent to the RCS and compared to a database to determine if the key code is valid. If a valid key code is recognised by the remote system the RCS then outputs a response to the terminal equipment to either advise the operator of required actions or to authorise the process request made by the remote equipment or system.

In a financial transaction system thresholds may be stored in the remote system to permit funds transactions at various levels or to provide access permission subject to further identity confirmation.

In the case of higher transaction thresholds or high security area access the system will upload either jpeg images of the user's signature, the user's image, or specified passwords to permit the operator to correctly identify the user and authorise the transaction or access request.

In the case of unattended entry access or unattended point of sale transactions the remote system would upload a request to the terminal equipment for the user to input a password or PIN number to permit processing.

Embodiment 1—Secure Identification of Personnel

Definition of Terms

CKD means the user key device (also referred to as “Sense-key”)

ID means Identification

RCS means Remote Computer System

RF means Radio Frequency

SC means Security Console

TRD means the RF transmitter and receiver apparatus or EMV compliant card reader device

ROM means Read Only Memory

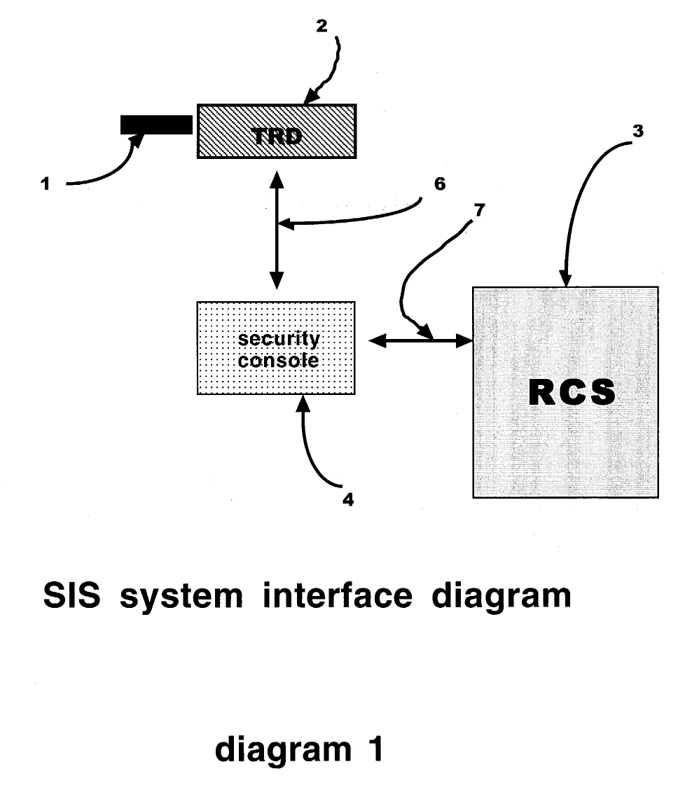

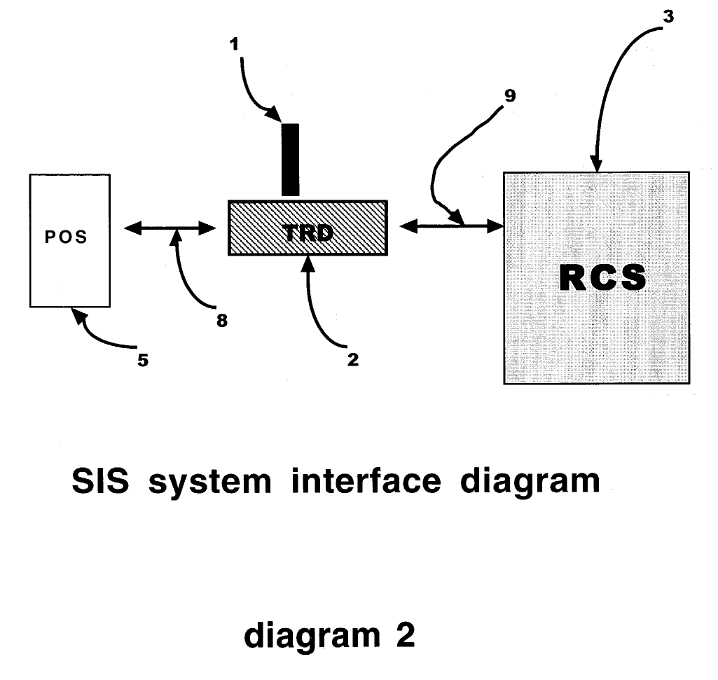

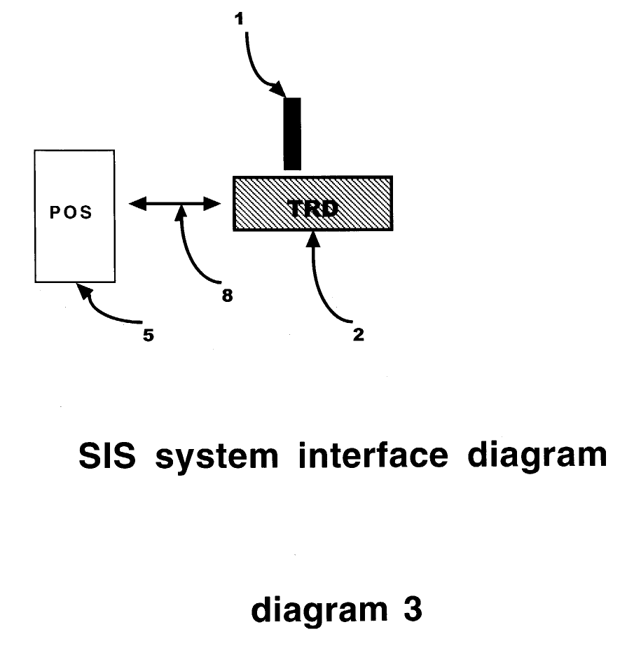

FIG. 1 depicts a block diagram for an embodiment of the invention whereby the user engages in a transaction to confirm their identity for the purpose of access control or other required process at an operator attended station.

The user must have a valid CKD.

For RFID operation the operator station has a clearly marked area for the user to stand in so as to ensure that the relevant CKD and no other is within target range.

The system consists of the following;

Item 1—CKD (contactless user key or EMV compliant card)

Item 2—TRD (a radio frequency functional transmitter and receiver device to interface with contactless key devices or an EMV compliant card reader to interface with EMV compliant cards)

Item 3—RCS (remote computer system)

Item 4—SC (security console)

Item 6—Data link between the TRD and the SC

Item 7—Data link between the SC and the RCS

Operator Attended Mode Operation (Practical Event Sequence)

The system is connected as shown in diagram 1.

(1) The user attends the access control and verification area.

(2) The user key is automatically read if contactless or read after insertion in a contact reader if an EMV type card.

(3) If more than one valid contactless key is in the target zone, the system displays a message on the operator's display and on the users' display to state “only one Sense-Key is permitted, please remove all other Sense-Keys from the transaction area”.

(4) If only one valid key is read the system will display a message on both operator and user displays to state that the Sense-Key has been read.

(5) The operator will query the level or type of access required by the user.

(6) The user will nominate a level of access or priority or destination as appropriate.

(7) The operator will then request an ID confirmation from the RCS.

(8) The RCS will respond by uploading either an image of the user, an image of their signature, a password to confirm or a predetermined question to be answered by the user in order to verify their identity.

(9) The operator would confirm the user's ID by whichever means was presented and either deny or permit access as appropriate.

(10) The user's attendance and response if incorrect or inconsistent would be recorded by the RCS.

(11) An image of the user may be recorded and sent to the RCS for storage.

Unattended Mode Operations (Practical Event Sequence)

The system is connected as shown in diagram 1.

The process is identical to that of operator attended mode operation except the operator is not present and the user is required to input either a password or respond to a predetermined question in order to verify their identity. An image of the user may be automatically recorded at the access point and sent to the RCS for storage or processing.

Operator Attended Mode Operation (Technical Event Sequence for RFID System)

The system is connected as shown in FIG. 1.

(1) When powered the TRD performs a continuous series of RF burst outputs at a predetermined rate. The receiver section will continuously process the reception of data which is coded in the required protocol that is broadcast by any valid transponder (CKD device) which is in range of it's receiving antenna.

(2) Upon entering the target read zone the user's CKD is energised and performs a predetermined operational sequence by according to the instruction data coded into it's onboard ROM register. The operational sequence is such that the CKD broadcasts it's level 1 ID code. This code is received by the TRD and recognised as being from a valid transponder. The TRD outputs to the RCS unit the complete level 1 ID data received.

(3) The RCS decodes the data received and accesses an internal memory register which contains specific data for the particular CKD. It simultaneously sends a message to the user display and to the operator display to state “Valid Sense-key read, please proceed”.

(4) If two or more CKD devices are read by the system simultaneously a message is displayed to request “Only one valid Sense-key permitted, please remove all other Sense-keys from area”.

(5) Noting the message confirming a single valid Sense-key, the operator now proceeds to query the user as to their required access level or destination.

(6) The operator requests the appropriate security confirmation from the RCS.

(7) The operator then confirms the displayed security data supplied by the RCS by visual inspection of the user themselves or of their signature if requested or of a password or answer to a predetermined question.

(8) Any discrepancies in user responses will be recorded by the RCS and permission will be denied.

Embodiment 2A—Operator Attended Financial Transactions

Definition of Terms

CKD means the user key device (also referred to as “Sense-key”)

DTL means Daily threshold limit

ID means Identification

POS means Point Of Sale equipment and system

RCS means Remote Computer System

RF means Radio Frequency

RFID means Radio Frequency Identification

ROM means Read Only Memory

STL means Standard Threshold Limit

TTL means Tertiary Threshold Limit

TRD means the RF transmitter and receiver apparatus

Diagram 2 depicts a block diagram for an embodiment of the invention whereby the user engages in a transaction to purchase goods at an operator attended checkout counter. In this embodiment the RCS may incorporate the financial service's internal accounting system.

The user must have a valid CKD.

For RFID operation the goods payment counter has a clearly marked area for the customer to stand in so as to ensure that their CKD and no other is within target range.

The system consists of the following;

Item 1—CKD (contactless user key or EMV compliant card)

Item 2—TRD (a radio frequency functional transmitter and receiver device to interface with contactless key devices or an EMV compliant card reader to interface with EMV compliant cards)

Item 3—RCS (remote computer system)

Item 5—POS (the vendor's point of sale terminal, cash register or stock tally equipment)

Item 8—Data link between the TRD and the POS

Item 9—Data link between the TRD and the RCS

Online Mode Operation (Practical Event Sequence 2A)

The system is connected as shown in diagram 2.

(1) The user brings goods or accounts payable to the checkout payment area.

(2) The user key is automatically read if contactless or read after insertion in a contact reader if an EMV type card.

(3) If more than one valid contactless key is in the target zone, the system displays a message on the operator's display and on the users' display to state “only one Sense-key is permitted, please remove all other SenseKeys from the transaction area”.

(4) If only one valid key is read the system will display a message on both operator and user displays to state that the Sense-Key has been read.

(5) The operator will assist with scanning of goods or accounts payable bar codes and the POS equipment will display a cumulative total value.

(6) The cumulative total value is also displayed on both the operators' display and the users' display.

(7) If the cumulative total value exceeds the available funds in all linked user accounts a message is displayed to state “Payment total is $XX above available funds value, please subtract some items to reduce total”.

(8) If the cumulative total value is less than the available funds in all linked user accounts a message is displayed to state “Payment total is $XX. Please proceed”.

(9) The operator would ask the user “Will that be all ?” and “Do you wish to withdraw cash ?”.

(10) If a cash withdrawal is requested and the amount entered by the operator for this makes the cumulative total value now exceed the available funds in all linked user accounts a message is displayed to state “New payment total is $XX above available funds value, please subtract some items to reduce total”.

(12) If the cumulative total value is still less than the available funds in all linked user accounts a message is displayed to state “New payment total is $XX. Please proceed”.

(13) The operator selects the “process transaction” key on their POS equipment which then displays a message to state “Transaction complete Thank you”.

(14) The POS equipment prints a receipt which states all item costs and payments for the user. This receipt has a user account ID code.

(15) The customer exits the transaction area with their goods and/or accounts.

Offline Mode Operations (Practical Event Sequence 2A)

The system is connected as shown in diagram 3.

The process is identical to that of Online mode operation except for steps (7), (8), (10) and (11) where “available funds in all linked user accounts “is replaced by “funds available in offline mode”.

The vendor's equipment will print a receipt for the transaction which shows the date and amount of transaction. The next receipt from an online transaction is appended with details of previous offline transactions including the user account code.

Online Mode Operation for Financial Transactions (Technical Event Sequence 2A Using RFID System)

The system is connected as shown in diagram 2.

(1) When powered the TRD performs a continuous series of RF burst outputs at a predetermined rate. The receiver section will continuously process the reception of data which is coded in the required protocol that is broadcast by any valid transponder (CKD device) which is in range of it's receiving antenna.

(2) Upon entering the target read zone the user's CKD is energised and performs a predetermined operational sequence by according to the instruction data coded into it's onboard ROM register. The operational sequence is such that the CKD broadcasts it's level 1 ID code. This code is received by the TRD and recognised as being from a valid transponder. The TRD outputs to the RCS unit the complete level 1 ID data received.

(3) The RCS unit decodes the data received and stores in a memory register the STL value for the particular CKD. It simultaneously outputs a message to the user display and to the operator display to state “Valid Sense-Key read, please proceed with transaction”.

(4) When the system operates in online mode, the RCS will communicate data to advise the threshold levels set for that CKD.

(5) If two or more CKD devices are read by the system simultaneously a message is displayed to request “Only one valid Sense-Key permitted, please remove all other Sense-Keys from transaction area”.

(6) Noting the message confirming a single valid Sense-Key, the operator now proceeds to scan bar codes from goods presented for purchase and/or from accounts presented for payment.

(7) If no goods or accounts are presented the operator would ask the customer if they wished to perform only a cash withdrawal.

(8) If goods are being purchased or accounts being paid, the scanning of bar codes by the vendors' POS equipment will display a total on its' display.

(9) This total is sent to the operators' and users' display which reads “Total transaction total is $XX. Please proceed”. During this process the RCS unit compares the tally with either the DTL value, or TTL value for that particular CKD.

(10) When all purchases and payments are entered, the operator would ask if a cash withdrawal is desired by the user. If cash withdrawal is requested, this amount is added to the tally by the operator keying in the appropriate amount after selecting the “cash out” function on their equipment.

(11) The requested amount for cash withdrawal is logged by the RCS unit which then facilitates debit from the particular user configured account for that purpose. If sufficient funds are available the RCS outputs data to the POS unit to which displays a message to state” New payment total is $XX. Please proceed”.

(12) In online mode the maximum daily cash withdrawal amount is set by the user, as is the choice of account from which that withdrawal is taken. In offline mode the cash withdrawal facility is limited to the amount remaining in the STL value for that particular CKD.

(13) The user can decide to cancel the whole or any part of the transaction at this point.

If the user agrees that the transaction is complete, the operator would press the “proceed” key and a message would be displayed to the user to say “Transaction complete. Thank you.”

(14) The RCS unit reads this command and effects the transfer of funds between the user's account(s) and the vendors' account.

(15) The vendors' equipment will print a receipt for the transaction which shows all items, payments, and withdrawals, and includes the date and a customer code number for their records. This receipt has a user account code which is supplied by the RCS. The customer code number on the receipt is unrelated to the level 1 ID code or any other data which is stored on the CKD.

Offline Mode Operation (Technical Event Sequence)

The system is connected as shown in diagram 3.

The Offline technical process is similar to that of Online operation, except the TRD unit does not communicate with the RCS during the transaction, and the transaction value is limited to the STL value read from the CKD.

The vendor's equipment will print a receipt for the transaction which shows the date and amount of transaction. The next receipt from an online transaction is appended with details of previous offline transactions including the user account code.

Embodiment 2B—Self Service Transactions

Diagram 2 depicts a block diagram for an embodiment of the invention whereby the user engages in a transaction to purchase goods at an unattended check-out counter. In this embodiment the RCS may incorporate the financial service's internal accounting system.

The user must have a valid CKD.

For RFID operation the goods payment counter has a clearly marked area for the customer to stand in so as to ensure that their CKD and no other is within target range.

The system consists of the following;

Item 1—CKD (contactless user key or EMV compliant card)

Item 2—TRD (a radio frequency functional transmitter and receiver device to interface with contactless key devices or an EMV compliant card reader to interface with EMV compliant cards)

Item 3—RCS (remote computer system)

Item 5—POS (the vendor's point of sale terminal, cash register or stock tally equipment)

Item 8—Data link between TRD and POS

Item 9—Data link between TRD and RCS

Online Self Service Mode Operation (Practical Event Sequence)

The system is connected as shown in diagram 3.

(1) The user brings goods or accounts payable to the checkout payment area.

(2) The user key is automatically read if contactless or read after insertion in a contact reader if an EMV type card.

(3) If more than one valid contactless key is in the target zone, the system displays a message on the user's display to state “Only one valid Sense-Key is permitted, please remove all other Sense-Keys from the transaction area”.

(4) If only one valid key is read the system will display a message on both operator and user displays to state that the Sense-Key has been read.

(5) The user scans the desired goods with the equipment provided by the vendor, and the cumulative payment total is shown on the user display.

(6) Cash withdrawals may be selected at any time subject to suitability of the vendor's installed equipment with the desired amount entered by the user by pressing appropriate buttons on the user control interface.

(7) If the cumulative total value exceeds the available funds in all linked user accounts a message is displayed to state “Payment total is $XX above available funds value, please subtract some items. to reduce total”.

(8) The user can select a key labelled “scan and delete item” at any time.

(9) If the cumulative total value is less than the available funds in all linked user accounts a message is displayed to state “Payment total is $XX. Please proceed”.

(10) The user can select a key labelled “complete transaction” at any time that the cumulative total is less than the available funds in all linked accounts.

(11) The POS equipment prints a receipt which states all item costs and payments for the user. This receipt has a user account ID code.

(12) The customer exits the transaction area with their goods and/or accounts.

Offline Self Service Mode Operation (Practical Event Sequence)

The system is connected as shown in diagram 3.

The process is identical to that of Online mode operation except that the maximum transaction value is limited to the DTL threshold.

The vendor's equipment will print a receipt for the transaction which shows the date and amount of transaction. The next receipt from an online transaction is appended with details of previous offline transactions including the user account code.

An image of the user may be automatically recorded at the access point of an offline mode transaction and later sent to the RCS for storage or processing.

Online Mode Operation (Technical Event Sequence)

The system is connected as shown in diagram 2.

(1) When powered the TRD performs a continuous series of RF burst outputs at a predetermined rate. The receiver section will continuously process reception of data which is coded in the required protocol that is broadcast by any valid transponder (CKD device) which is in range of it's receiving antenna.

(2) Upon entering the target read zone the user's CKD is energised and performs a predetermined operational sequence by virtue of the instruction data coded into it's onboard ROM register. The operational sequence is such that the CKD broadcasts it's level 1 ID code. This code is received by the TRD and recognised for being from a valid type of transponder. The TRD outputs to the RCS unit a data state signifying that recognition as well as the complete level 1 ID data received.

(3) The RCS unit decodes the data received and stores in a memory register the STL value for the particular CKD and simultaneously outputs a message to the user display to state “Valid Sense-Key read. Please proceed with the transaction”.

(4) When the system operates in online mode the RCS will communicate data to advise the threshold levels set for that CKD.

(5) If two or more CKD devices are read by the system simultaneously a message is displayed to request “Only one valid Sense-Key is permitted, please remove all other Sense-Keys from the transaction area”.

(6) When the message “Valid Sense-Key read” is displayed, the user is prompted by a second message which states “Please scan goods or account bar codes now”.

(7) If available from the vendors' equipment, a cash withdrawal may be selected by the user and the amount entered by keypad or touch-screen. This amount is added to the tally value.

(8) At any time the user may select the key labelled “complete transaction”.

(9) The cumulative total of all items scanned is displayed as long as the transaction total value remains under the available funds value of all linked user accounts.

(10) If at any stage of the payment tally process the total exceeds the CKD's DTL value, a message is displayed to state “Available funds value exceeded, please select delete-item key and re-scan”.

(11) The requested amount for cash withdrawal is logged by the RCS unit which then facilitates a debit from the particular user configured account for that purpose. If sufficient funds are available the RCS outputs data to the POS unit which displays a message to state “Total transaction value is $XX. Please proceed”.

(12) In online mode the maximum daily cash withdrawal amount is set by the user as is the choice of account from which that withdrawal is taken.

(13) The user can decide to cancel the whole or any part of the transaction before selecting the “complete transaction” key.

(14) If the user agrees that the transaction is complete, the operator would press the “proceed” key and a message would be displayed to the user to say “Transaction complete”.

(15) When the “complete transaction” key is selected, the RCS unit effects the transfer of funds between the users' account(s) and the vendors' account.

(16) The vendors' equipment will print a receipt for the transaction which shows all items, payments, and withdrawals, and includes the date and a customer code number for their records. This receipt has a user account code which is supplied by RCS. The customer code number on the receipt is unrelated to the ID level 1 code or any other data stored on the CKD.

Offline Mode Operation (Technical Event Sequence)

The system is connected as shown in diagram 3.

The technical process is similar to that of Online mode operation except the TRD unit does not communicate with the RCS during the transaction and the transaction value is limited to the STL value read from the CKD.

The vendor's equipment will print a receipt for the transaction which shows the date and amount of transaction. The next receipt from an online transaction is appended with details of previous offline transactions including the user account code.

An image of the user may be automatically recorded at the access point of an offline mode transaction and later sent to the RCS for storage or processing.

1. A claim is made for a method and system to facilitate secure personal identification of an individual where a user key device is employed to access data stored on a remote system and where all relevant data is stored only on that remote system and that data is accessed only by proprietary equipment at a point of operation where the data is temporarily uploaded to and displayed if required on an operator's equipment for verification.

2. As claimed in claim 1, a method and system to manage and/or enable secure remote funds transfer whereby a user key device is employed to permit local point of sale equipment and/or the operator of that equipment to verify the ID of a user by accessing personal identification data stored only on a remote facility and where no form of personal ID is visible on or stored on the user's key device at any time.

3. As claimed in claim 1, a method and system to manage and/or enable secure remote funds transfer between a user's account and a vendor's account within the financial services system.

4. As claimed in claim 1, a method for initiating a secure transaction which employs data exchange between a user held key device and equipment which is interfaced to the operation of a point of sale system.

5. As claimed in claim 1, a method for securely storing user data to permit rapid payment processing at a vendor's premises.

6. As claimed in claim 1, a method to manage data exchange between a user key device, a vendor point of sale system, and bank internal account systems in order to complete the transfer of funds between the user account and the vendor account in a secure manner.

7. As claimed in claim 1, a method and system to effect a user defined structure for the setting of transaction value thresholds from the user's linked accounts within the banking system, for the purpose of providing user control over particular security options.

8. As claimed in claim 1, a method and system to enable the secure retrieval from remote storage and subsequent display of images of a user's face or signature or password as desired to permit verification of identity.

9. As claimed in claim 1, a method and system to permit secure access control to restricted or high security risk areas.

10. As claimed in claim 1, a method and system to provide a means of securely identifying individuals at a point of operation whereby none of the individual's remotely stored identifying data can be manipulated, altered or substituted.

11. As claimed in claim 1, a method and system for securely storing user data whereby none of that data can be accessed for the purpose of alteration, copying or manipulation.
